(19) United States
(12) Patent Application Publication
(10) Pub. No.: US 2002/0050710 A1
(43) Pub. Date: May 2, 2002

(54) Cover for an album and the like and a binding method using the same

(76) Inventor: Shingo Kurahashi, Izumo (JP)

Correspondence Address: THOMPSON HINE L.L.P., 2000 COURTHOUSE PLAZA , N.E., 10 WEST SECOND STREET, DAYTON, OH, 45402, US

(21) Appl. No.: 09/924,895

(22) Filed: Aug. 8, 2001

(30) Foreign Application Priority Data
Aug. 24, 2000 (JP) 2000-253936

(51) Int. Cl. B42D 3/00; G09F 3/00

(52) U.S. Cl. 281/29

(57) ABSTRACT

This is to provide a cover suitable to hollow-backed binding and provide a binding method for an album and the like for obtaining a well-bound appearance using the cover at low cost and easy to turn over. A cover is composed of a decoration cloth, a pair of substratum paper and a spine affiche adhered on required positions on the back of the decoration cloth, an interconnected reinforcement paper adhered to substratum paper to create a space between a spine affiche and a reverse paper. Also, the present invention adopts a binding method for binding with a process of adhering a plurality of cardboards, wherein heat-soluble adhesive are applied on a binding side thereof to a back surface of a spine of the cover while the plurality of cardboards have intervals therebetween, a process of keeping a cover at a room temperature, a process of bulging and rounding a spine portion by stressing ravine portions of right and left while heat-soluble adhesive is consolidating, and a process of consolidating the heat-soluble adhesive completely by fixing and holding the same until cooled down to a room temperature.

### BACKGROUND OF THE INVENTION

1. Field of the Invention

The present invention relates to a structure of a front cover for an album, a scrapbook and the like having intervals between cardboards wherein heat-soluble adhesive are used, and hollow-backed binding using a foresaid front cover.

2. Description of the Prior Art

There already exist an album, a scrapbook and the like bound with intervals between cardboards using heat-soluble adhesive. For example, a cardboard book disclosed in Japanese Utility Model Official Gazette No. S63-25176 has a structure comprising a cover body having a cover portion a, a cover portion b and a spine portion c, a plurality of cardboards d positioned as shown in FIG. 5 having intervals equivalent to a predetermined thickness of a cardboard, and in the vicinity of an edge at a binding side of the plurality of cardboards, heat-soluble adhesive e intervening between cardboards to keep the intervals and gluing an edge surface of the edge at a binding side of the plurality of cardboards to an inside of the spine. Types of cardboards vary in applications from for a photo album, a postcard album, a stamp collection book, a coin collection book to a scrapbook.

Owing to such cardboard book, a bound book having intervals between cardboards is easily obtained at low price. Also an album, wherein an end of an album does not exceed a width of a spine even if a binder insert gets thicker by placing pictures on a binder insert, can be offered.

However, a backstrip of a cardboard (an edge portion at a binding side) comparatively becomes pliable because of a structure of such bound book having intervals between cardboards using heat-soluble adhesive. Therefore, the cardboard could not be used in conventional binding methods such as round-arch-spine binding and hollow-backed binding, wherein a hard backstrip is required. For the reason above, under the present condition, only bound books of low cost have been commercialized such as a handy-binding-type album, wherein a binder insert is directly adhered to the squarish spine.

An album has an essential product character, which is to store and keep photographs and other memorials for many years. For that reason, gorgeous and luxurious types of albums are required as well as low price and handy types thereof. A problem has been pointed out that a product of earnest binding type such as round-arch-spine binding and hollow-backed binding cannot be provided with the structure described above.

Here round-arch binding are further explained. According to conventional round-arch binding, a backstrip of a binding object is shaped into a round and then a cover is covered along therewith. Not that a backstrip of a binding object is formed in accordance with a round-arch-spine, but that a spine has to be shaped into a round to suit the backstrip of the binding object. Accordingly, cardboards having intervals therebetween and hinged binder inserts for an album are difficult in binding and impossible to use in round-arch binding.

The present applicant previously filed a Japanese patent application No. 2000-146408, wherein a spine affiche is resinous synthesis paper and heat-formed to obtain a round-arch binding. However, a spine of a bound book produced by this technology is fixed, which indicates that a problem of difficulty in turning over to double spread still remains unsolved.

### SUMMARY OF THE INVENTION

In the view of the problem, the present invention provides a cover suitable for hollow-backed binding in binding having intervals between cardboards using heat-soluble adhesive and allows to obtain a well-bound appearance easily at low cost by suggesting a binding method using the cover. Also, the present invention has a purpose to provide an album, which is luxurious in appearance, easy to turn over to facing pages and easy to use.

To solve the each problems, the invention described in claim 1 adopts a structure comprising a decoration cloth, a pair of substratum paper and a spine affiche adhered on a predetermined position in a back surface of the decoration cloth, an interconnected reinforcement paper adhered on substratum papers of right and left to form space between a spine affiches and a reverse paper sheathing a back surface of the cover.

As space is formed between a spine affiche and an interconnected reinforcement paper, a cover of the above structure can be hollow-backed binding with the space after binding.

The invention described in claim 2 adopts a binding method having a process of adhering a plurality of cardboards, wherein heat-soluble adhesive are applied on a binding side thereof, to a back surface of a spine of a cover described in claim 1 while the plurality of cardboards have intervals therebetween, a process of keeping a cover, which is closed, at a room temperature, a process of bulging and rounding a spine portion by stressing from ravine portions of right and left outside of a cover in the middle of a state that heat-soluble adhesive is consolidating, and a process of consolidating the heat-soluble adhesive completely by fixing and holding the same until cooled down to a room temperature.

According to the above binding method, a bound book with a round-spine is obtained by an eminently simple process. Also, as a spine affiche and an interconnected reinforce paper is not adhered together in the cover, a bound book is able to have a round-spine meanwhile being a hollow-backed binding. Therefore, a well-bound appearance can be obtained easily at low cost and a luxurious album can be produced. Moreover, an album, which is easy to turn over and to see facing pages can be provided with hollow-backed binding.

### BRIEF DESCRIPTION OF THE DRAWINGS

FIG. 1 A is a plane view showing an example of a cover in the present invention. B is a cross sectional view taken along with A-A.

FIG. 2 is a description of a binding method in the present invention.

FIG. 3 is a description of a method for rounding a spine.

FIG. 4 is partially enlarged sectional view showing the state of a bound book being opened.

FIG. 5 is partially enlarged sectional view showing an example of a conventional bound book.

### DETAILED DESCRIPTION OF THE PREFERRED EMBODIMENT

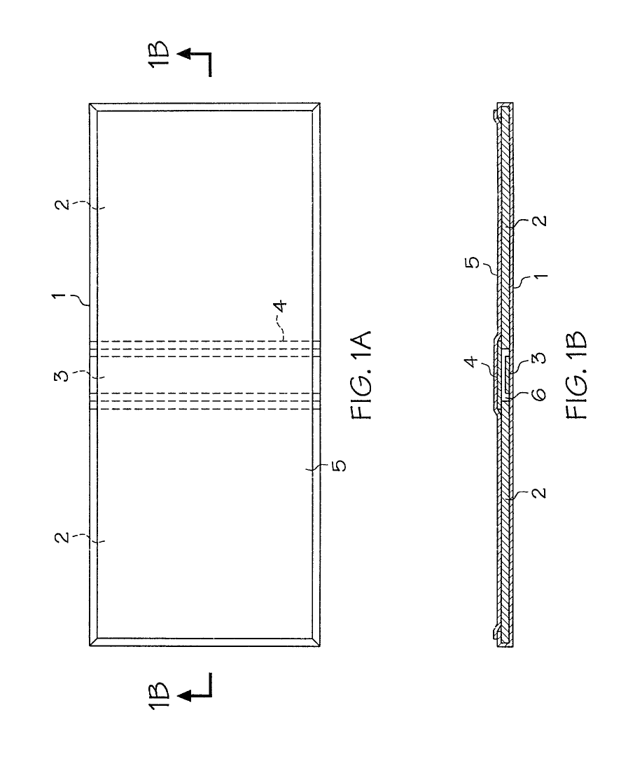

Hereafter, preferred embodiments of a cover for an album and the like in the present invention is described referring to drawings. FIG. 1 is a plane view showing an example of a cover for an album and a cross sectional view taken along with A-A lines. In this FIG., 1 is a decoration cloth sheathing the whole cover, 2 is a pair of substratum paper to be a base body of a cover and 3 is a spine affiche to be a base substance of a spine. 4 is an interconnected reinforcement paper adhered on substratum paper of right and left 2 to cover the spine affiche 3 on a back surface of a cover and 5 is a reverse paper sheathing the whole of a back surface of a cover

A manufacturing procedure of this cover is to apply an adhesive on all over a back surface of a decoration cloth 1 and to adhere substratum paper of right and left 2 and a spine affiche 3 to predetermined positions. Then, after turning up top and bottom of the decoration cloth 1, proceed to turning up and adhering an end portion thereof. Corners are treated suitably. Then a belt-shaped interconnected reinforcement paper 4 is adhered to substratum paper of right and left 2 for sheathing a spine affiche 3 while creating a space 6 between the spine affiche 3 by keeping apart. A reverse paper 5 is adhered to the whole of a back surface while keeping a slight of space at four corners. A cover of an album is produced with the above processes.

After binding, a cover of the above structure can be in the state of hollow-backed with a space 6 as a spine affiche 3 and an interconnected reinforcement paper 4 is apart from each other by the space 6.

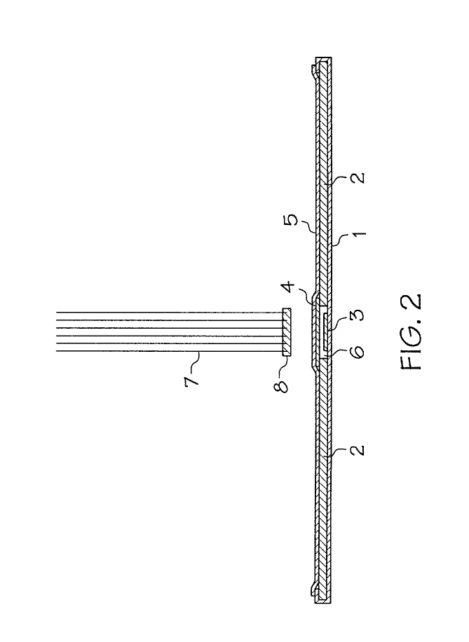

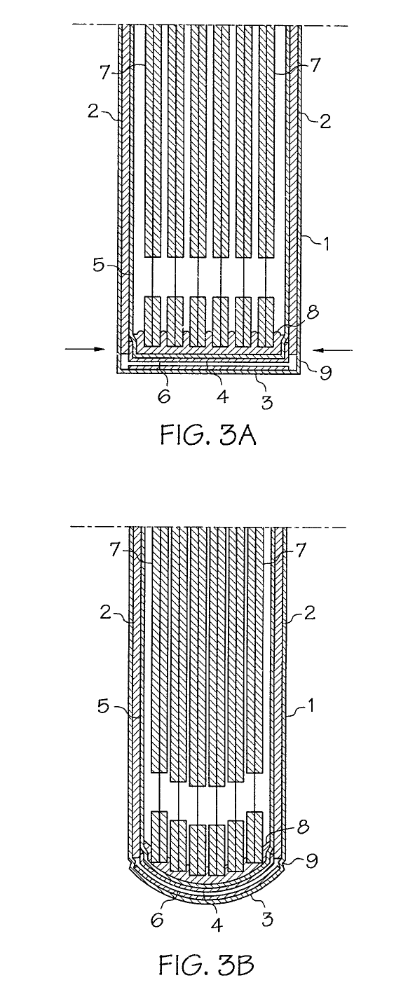

Hereinafter, a binding method using this cover is to be described. As shown in FIG. 2, cardboards 7, wherein heat-soluble adhesive 8 is applied on a biding side thereof while maintaining intervals therebetween are adhered on a back portion of spine of the cover opened. This is the same procedure with conventional binding using heat-soluble adhesive. For example, a spacer is positioned between a plurality of cardboards 7 and a pair of holders (not shown in figures) is to hold thereof. Then a binding side of the cardboards is applied with heat-soluble adhesive and pressed to adhere to a back surface of a spine.

As shown in FIG. (A), a cover is kept closed and stood at a room temperature. At the point that heat-soluble adhesive 8 is cooled down and solidified to some extent, a pressure is put on a portion to be a ravine portion 9 from right and left outside of a front cover with a suitable method. With the pressure, a ravine portion 9 is compressed to the direction of a width of a book, which results in spine bulged outside. By keeping this situation until heat-soluble adhesive 8 is cooled down to a room temperature, heat-soluble adhesive is to be completely solidified maintaining a rounded shape. As a spine affiche is settled in a rounded shape, a bound book with a cover rounded can be obtained.

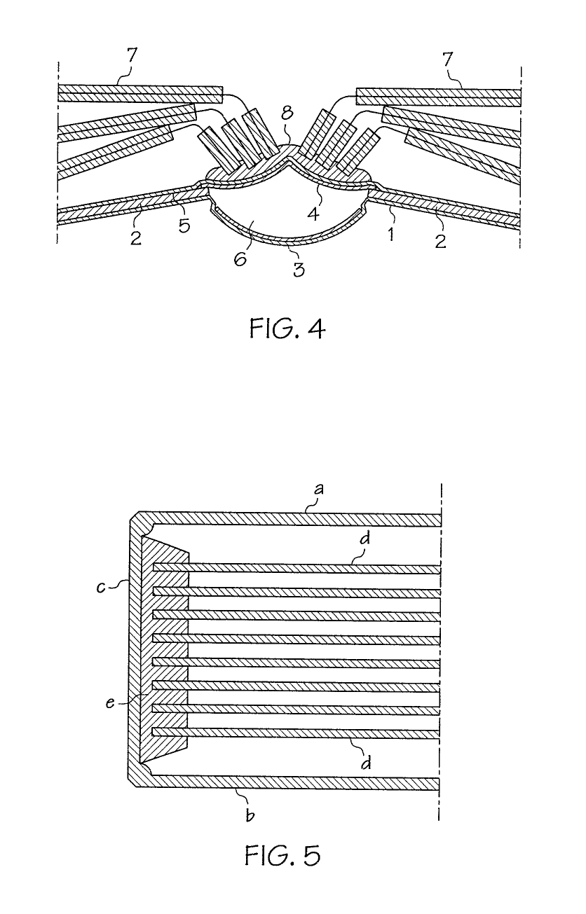

As a spine affiche 3 and an interconnected reinforcement paper 4 in a bound book produced by the above method is not adhered together, a space 6 is formed inside of a spine of a bound book, and therefore, as shown in FIG. 4, when cover is opened, a bound book can be a hollow-backed binding with a cylindric space.

As described above, a cover for an album and the like in the present invention adopts a structure providing an interconnected reinforcement paper on a spine affiche while keeping them apart. With such a structure, even contents are adhered to a spine, a space is formed so that hollow-backed binding is produced easily. Accordingly, a bound book is easy to turn over and to see without a cardboard stood.

Also, according to the binding method described above, a rounded cover can be composed with an exceedingly simple way as a spine is bulged with a pressure on a ravine portion of a cover from right and left outside. In a binding having intervals between cardboards, a well-bound appearance book such as a luxurious album can be provided with a rounded cover easily at low cost.

A rounded portion of a spine has a double structure of a spine affiche and an interconnected reinforcement paper and can be hollow-backed binding, which provides an album easy to open and see double spread.

What is claimed is:

1. A cover for an album and the like comprising a decoration cloth, a pair of substratum paper and a spine affiche adhered on a predetermined position in a back surface of the decoration cloth, an interconnected reinforcement paper adhered on substratum papers of right and left to form space between a spine affiche and a reverse paper sheathing a back surface of the cover.

2. A binding method for an album and the like characterized by a process of adhering a plurality of cardboards, wherein heat-soluble adhesive are applied on a binding side thereof to a back surface of a spine of a cover described in claim 1 while the plurality of cardboards have intervals therebetween, a process of keeping a cover, which is closed, at a room temperature, a process of bulging and rounding a spine portion by stressing from ravine portions of right and left outside of a cover in the middle of state that heat-soluble adhesive is consolidating and a process of consolidating the heat-soluble adhesive completely by fixing and holding the same until cooled down to a room temperature.
